(19) United States
(12) Patent Application Publication
(10) Pub. No.: US 2025/0044761 A1
(43) Pub. Date: Feb. 6, 2025

(54) METHOD FOR PREDICTING AND PLANNING RENEWABLE ENERGY MAINTENANCE AND SUSTAINMENT ACTIVITIES

(71) Applicant: 60Hertz Energy, Anchorage, AK (US)

(72) Inventors: Piper Star Foster Wilder, Anchorage, AK (US); Raymond T. Deiotte, Parker, CO (US)

(21) Appl. No.: 18/788,576

(22) Filed: Jul. 30, 2024

Related U.S. Application Data
(60) Provisional application No. 63/516,802, filed on Jul. 31, 2023.

(51) Int. Cl. G05B 19/048

(52) U.S. Cl. CPC G05B 19/048; G05B 2219/2639

(57) ABSTRACT

The technology leverages data sources into an insight generation system to generate a recommendation for a renewable energy asset. The technology combines historical operational data and real-time operational data associated with the renewable energy assets and incorporates historical environmental data and real-time environmental data to include forecasts of weather activity. An insight generation engine ingests the combined and incorporated data to generate an insight that enables data-driven decisions related to operation and sustainment of a resource associated with the renewable energy asset. The insight is associated with optimization, emplacement, or substantiality of the resource.

### CROSS-REFERENCE TO RELATED APPLICATIONS

This application claims the benefit of U.S. Provisional Patent Application No. 63/516,802, filed Jul. 31, 2023, which is incorporated by reference herein in its entirety.

### BACKGROUND

Solar energy and energy storage have decreased in price and increased in share of national electricity production globally. More than twenty climate-induced storms that yield losses greater than $1B have increased each of the past three years. As solar and storage yield measurable contributions to cheaper and more resilient energy, optimizing these assets' operations is often overlooked.

Solar energy operates based on the availability of sunlight. This means that, on cloudy or rainy days, enough energy is not generated to provide a sufficient source of power. Transmission electric utilities contract with developers to supply solar kilowatts to the grid, but in the event of underproduction, given weather or poor maintenance, the utility falls back to other generation types or contracts. Required maintenance can include panel cleaning, which independent power producers may ignore or be unwilling to manage. Extreme weather significantly influences solar and battery performance, let alone seasonal or environmental factors.

### BRIEF DESCRIPTION OF THE DRAWINGS

Detailed descriptions of implementations of the present invention will be described and explained through the use of the accompanying drawings.

FIG. 1 is a block diagram that illustrates the domain of the disclosed technology, leveraging multiple data sources into an insight generation system for recommendations on optimal renewable energy asset and system emplacement and sustainability in a decision support system.

FIG. 2 is a process flow diagram that illustrates the process for fusing operational and environmental data that informs, trains, tests, and operates predictive maintenance and planning activities.

FIG. 3 is a process flow diagram that illustrates the insight generation engine construct for operating on fused data sources.

FIG. 4 is a block diagram that illustrates the decision support system that presents the insights generated by the disclosed technology.

FIG. 5 is a block diagram that illustrates an example of a computer system in which at least some operations described herein can be implemented.

The technologies described herein will become more apparent to those skilled in the art from studying the Detailed Description in conjunction with the drawings. Embodiments or implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

The disclosed technology leverages multiple historical and real-time data sources to generate insights to optimize renewable energy systems planning, design, and operations. For example, the disclosed technology could enable a utility scale solar asset manager to compare energy generation from real-time SCADA (Supervisory Control and Data Acquisition) and an on-site soiling station with historical weather data in order to evaluate if soiling mitigation should be conducted or planned in the next ten days or another time.

The technology includes a collection of data fusion and insight generation algorithms and systems that understand the relationships between renewable energy system operations and environmental factors to positively impact the cost of operations, the quantity of kilowatt hours generated, the complexity of maintenance, the frequency and method of maintenance tasks, the operational lifespan of renewable energy systems, the planning for new or upgraded assets at this or future sites, and other capabilities. For example, the data fusion and insights could enable original equipment manufacturers (OEMs) of battery energy storage systems (BESS) to innovate enclosures for these systems to protect against both harsh cold, as well as internally generated thermal runaway events. Alternatively, independent system operators or commodity day traders could calculate the impact of upcoming weather events on expected generation from large portfolios of renewables.

The current art in this space includes, at best, manual collection of data and interpretation by subject matter experts and, at worst, is performed ad hoc to leverage minimal data and relies heavily on subject matter expert intuition and experience. The disclosed technology also includes a number of algorithms for data manipulation and normalization, event prediction, appropriate action postulation, and automated heuristics development organized as a system to generate decision recommendations inside a decision support system that has the ability to automate and activate external processes and applications from the system described herein.

The description and associated drawings are illustrative examples and are not to be construed as limiting. This disclosure provides certain details for a thorough understanding and enabling description of these examples. One skilled in the relevant technology will understand, however, that the invention can be practiced without many of these details. Likewise, one skilled in the relevant technology will understand that the invention can include well-known structures or features that are not shown or described in detail to avoid unnecessarily obscuring the descriptions of examples.

### Techniques for Optimizing Renewable Energy Systems

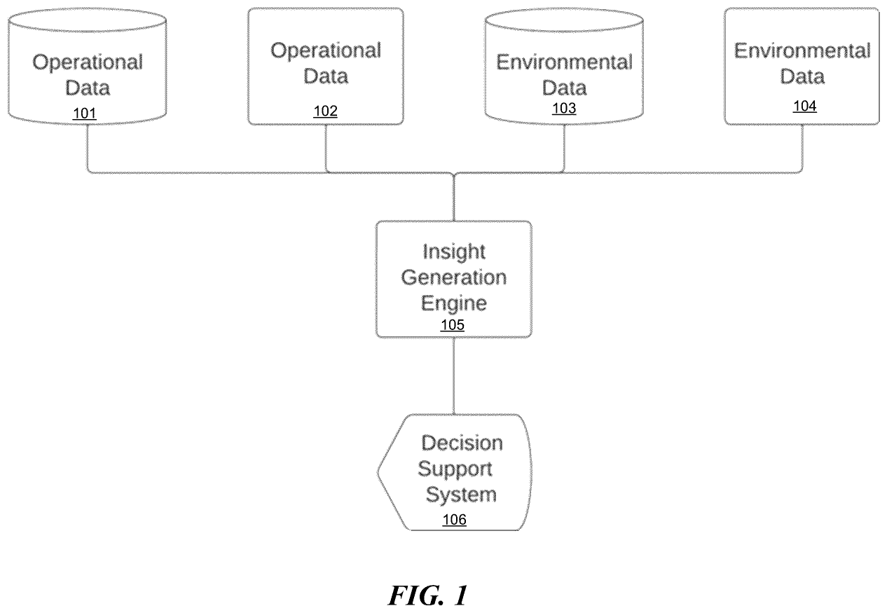

FIG. 1 is a block diagram that illustrates the domain of the disclosed technology, leveraging multiple data sources for processing by an insight generation system for recommendations on optimal renewable energy asset and system emplacement and sustainability in a decision support system. For example, a 5 MW solar garden is likely to be sited adjacent to agriculture, wherein agricultural residues, dust, and higher particulate matter (environmental factors), as well as increased frequency of wildfire in the arid west (a compounding environmental factor), may result in the need to manually clean solar modules more frequently or encourage agrivoltaics to reduce dust. The insight engine could generate specifics on increased panel cleaning or the type of vegetation to encourage in this location.

As articulated in FIG. 1, the system blends historical operational data with real-time operational data at 101 and 102. Additionally, the system incorporates historical and real-time environmental data to include forecasts of weather, as seen at 103 and 104. Examples of the environmental data include precipitation, irradiance, winds, proximity to grassland vegetation, or corn crops. Examples of operational data include output and storage profiles, indications of the presence of sheep grazing or not, the presence of agrivoltaics, and the type of soiling mitigation accomplished.

That data is then ingested into an insight generation engine, as seen at 105, which operates on the data and produces insights that can be decided upon. Examples of insights include facts like the presence of multiple years of urban air pollution accumulated on panels now yielding a measurable decrease in generation; or that upcoming snowfall will be followed by rain and ten subsequent days of freezing, cloudy days and that cleaning subcontractors are already booked on adjacent jobsites. At 106, the insights generated from the insight engine are represented in such a way that a decision-maker can make data-driven decisions about the operations and sustainment of their resources. Examples of the data-driven decisions include the decision to increase the service contract by $10,000 upon renewal to cover the high cost of a cleaning atop a large urban building or to proactively schedule snow removal immediately after a storm and before rain to prevent the forecast storm cycle from adhering snow for the rest of winter.

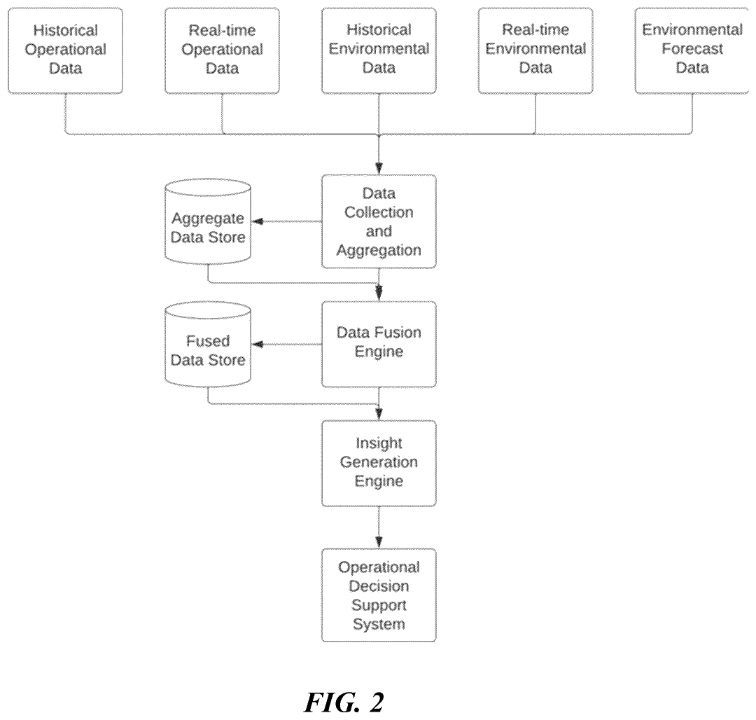

FIG. 2 is a process flow diagram that illustrates a process for fusing operational and environmental data that informs, trains, tests, and operates predictive maintenance and planning activities. Examples of predictive maintenance include identifying underperformance of an inverter, which indicates failure in the next twelve months; that hot spots in a section of modules indicate a need to replace them in the next six months; or that BESS performance is hampered by dirty air filters annually in May, given pollen in the environment, such that the filters should be changed preemptively in April. Examples of planning activities include site selection that reviews the availability (or not) of water in a region and responds accordingly or the colocation (or not) of a BESS to solar that is likely to be disabled frequently by wildfire ash, thus demanding larger BESS sizing. The system incorporates historical and real-time operational and environmental data in an aggregation engine that stores and normalizes the incoming data for use in later parts of the process.

The storage process keeps the raw incoming data in its native form for downstream validation and verification of results and to ensure that a copy of the data is retained for potential quality checking. The normalization process reshapes the incoming data, removing features and performing a quality check on the data to ensure the quality of the data for downstream processes. For example, sensor calibration activities, data processing anomalies, and other extreme outliers will be culled from the dataset, and data can be mapped to the same spatiotemporal grid.

The normalization process is informed by experimentation and model development offline to identify and understand relationships between required insights and features of each dataset. For example, certain decisions like the deployment of a cleaning team could possibly rely heavily on only precipitation, soiling, and output of the site, but wind could also be a factor in that decision-making process. Based on historical operations and the model, wind may or may not be included if the type of soiling has a low correlation to the soiling decision. The normalized data is also stored in the aggregate datastore for usage downstream. For real-time processing and insight generation, the normalized data is passed directly to the fusion engine. The data fusion engine accepts the normalized data and fuses it into a single data source. This process involves aligning temporal and spatial aspects of the data, interpolating where necessary, and generating a single data product for consumption by the insight generation engine. For example, all of the historical data around precipitation, wind, irradiance, soiling, particulate matter, ash deposition, and generation can all be output in a single schema so that all of the data features can easily be retrieved and utilized in subsequent processes.

Instantiations of the fusion engine can accomplish interpolation temporally and spatially via myriad of accepted techniques ranging from linear interpolation to agent-based modeling and multi-hypothesis, meta-heuristic optimization. Once the data are fused, they are stored for later use, uncertainty quantification, verification and validation, and other quality assurance activities. For real-time processing, data are delivered directly to the insight generation engine for batch processing, and the insight generation engine extracts data from the fused data store.

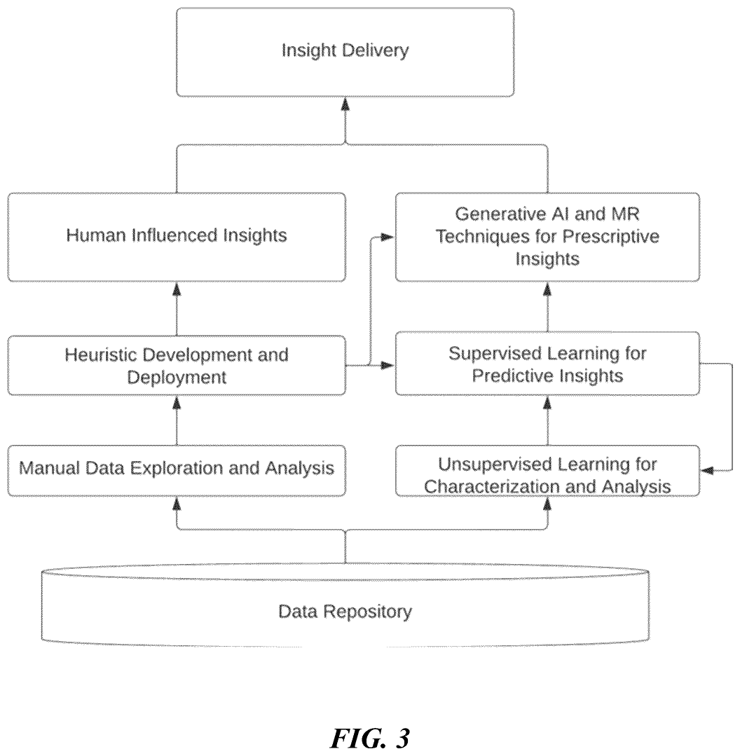

FIG. 3 is a process flow diagram that illustrates the insight generation engine construct for operating on fused data sources. The insight generation engine has two principal components to its algorithm. One is the exploration, model development, and training engine, and the other is an operational instantiation of developed models that generate insights to be delivered to the operational decision support system. The exploration, model development, and training engine identifies significant features and relationships in the fused data and develops models that can be used to predict behaviors and outcomes and analyze data against established heuristics. Subsequently, the engine leverages the significant data features and relationships to train models chosen by the system or by the administrator of the system.

Instantiations of the exploration, model development, and training engine may be constructed with any single or combination of insight generation algorithms such as convolutional neural networks, deep learning algorithms, other machine learning algorithms, other machine reasoning algorithms, modeling and simulation techniques, or optimization algorithms. The operational insight generation engine leverages models that have been trained and deemed acceptable for use and promoted into production and feeds them data in real time or from the fused data store to generate operational insights-typically predictions, prescriptions, and other analyses.

For example, data from a model could prescribe when to ignore a drop in energy production, given adjacency to fire, wind, weather, or particulate matter in the atmosphere, given the expectation that regular production will resume within twelve hours. In some cases, human-influenced insights are leveraged into the system and blended or used to otherwise tune the insights generated by automated processes. For example, operations directors could leverage their knowledge of the mechanized soiling mitigation tools (robots or machines) available for their sites and expand the parameters of the model; past costs paid to clean systems of a specific megawatt size could be input for future calculations. These can be generated as heuristics, feedback loops, or other methods for memorializing insights.

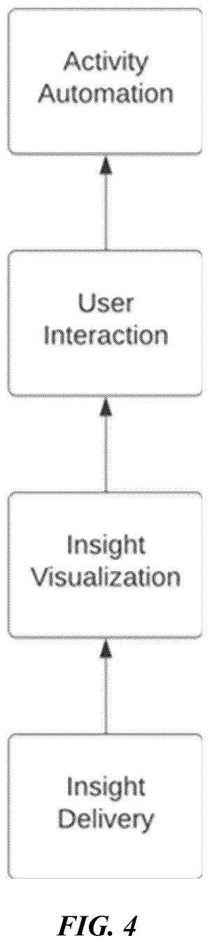

FIG. 4 is a block diagram that illustrates the decision support system that presents the insights generated by the operational insight generation engine. The decision support system integrates the insights generated and provides visual feedback and recommendations to the user as well as providing automation of tasks that can be automated based on recommendations and insights. For example, an operations director could interact with the model and input assumptions, then refine assumptions to create a yet-more helpful decision-support tool for a fleet of Photovoltaic (PV) or BESS or wind projects. The first part of the decision support system focuses on visualizing any of the insights that are delivered from the insight engine. Examples of visualizations include a color-coded heat map of a multistate portfolio of renewable assets and the degree to which they are impacted by adjacent wildfires or an interactive bell curve chart with a slider that references weather hindcasts to ascertain the degree of generation loss expected from the next snowstorm. A visualization is tailored based on use case, insight, and other user-tailored requirements, for example.

For example, if a dominant use case for a BESS is to firm intermittent renewables in a microgrid application, the visualization may depict the forthcoming cycles necessary to backfill the expected drop in PV generation. The application allows users to interact with the visualizations as well as other recommendations that are portrayed visually in the visualization system. For example, a utility generation foreman may be able to predict the impact of early spring storms on certain sections of distribution lines and thus dispatch vegetation management personnel to remove hazard trees and trim low-hanging branches to prevent power outages using a vegetation management overlay. Those inputs from the user are reformed and articulated in a way that they can be stored and logged as well as acted upon by the activity automation engine. The activity automation engine puts into play mechanisms that can automate actions or activities in the system or in other systems that may be connected to the computer system that is hosting the application and put those actions into play, logging the activities and any feedback provided. For example, the algorithm could drive an automated deployment engine that signals and directs cleaning crews to stations at the appropriate time to maximize cleaning activities.

### Computer System

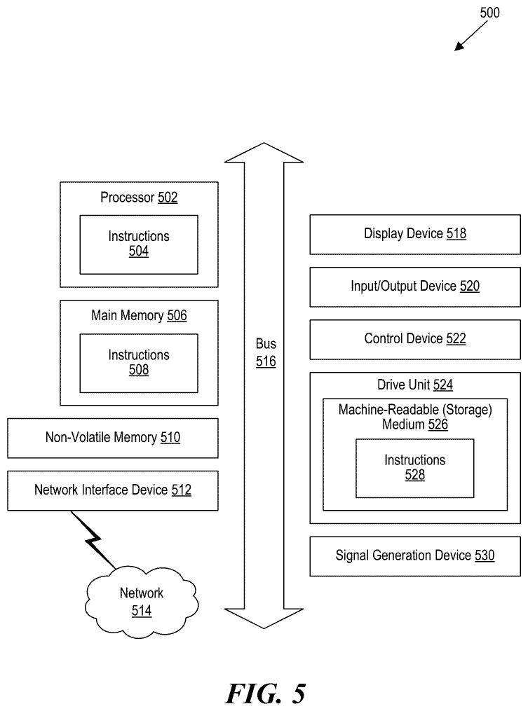

FIG. 5 is a block diagram that illustrates an example of a computer system 500 in which at least some operations described herein can be implemented. As shown, the computer system 500 can include: one or more processors 502, main memory 506, non-volatile memory 510, a network interface device 512, a video display device 518, an input/output device 520, a control device 522 (e.g., keyboard and pointing device), a drive unit 524 that includes a machine-readable (storage) medium 526, and a signal generation device 530 that are communicatively connected to a bus 516. The bus 516 represents one or more physical buses and/or point-to-point connections that are connected by appropriate bridges, adapters, or controllers. Various common components (e.g., cache memory) are omitted from FIG. 5 for brevity. Instead, the computer system 500 is intended to illustrate a hardware device on which components illustrated or described relative to the examples of the figures and any other components described in this specification can be implemented.

The computer system 500 can take any suitable physical form. For example, the computing system 500 can share a similar architecture as that of a server computer, personal computer (PC), tablet computer, mobile telephone, game console, music player, wearable electronic device, network-connected (“smart”) device (e.g., a television or home assistant device), AR/VR systems (e.g., head-mounted display), or any electronic device capable of executing a set of instructions that specify action(s) to be taken by the computing system 500. In some implementations, the computer system 500 can be an embedded computer system, a system-on-chip (SOC), a single-board computer system (SBC), or a distributed system such as a mesh of computer systems, or it can include one or more cloud components in one or more networks. Where appropriate, one or more computer systems 500 can perform operations in real time, in near real time, or in batch mode.

The network interface device 512 enables the computing system 500 to mediate data in a network 514 with an entity that is external to the computing system 500 through any communication protocol supported by the computing system 500 and the external entity. Examples of the network interface device 512 include a network adapter card, a wireless network interface card, a router, an access point, a wireless router, a switch, a multilayer switch, a protocol converter, a gateway, a bridge, a bridge router, a hub, a digital media receiver, and/or a repeater, as well as all wireless elements noted herein.

The memory (e.g., main memory 506, non-volatile memory 510, machine-readable medium 526) can be local, remote, or distributed. Although shown as a single medium, the machine-readable medium 526 can include multiple media (e.g., a centralized/distributed database and/or associated caches and servers) that store one or more sets of instructions 528. The machine-readable medium 526 can include any medium that is capable of storing, encoding, or carrying a set of instructions for execution by the computing system 500. The machine-readable medium 526 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory 510, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 504, 508, 528) set at various times in various memory and storage devices in computing device(s). When read and executed by the processor 502, the instruction(s) cause the computing system 500 to perform operations to execute elements involving the various aspects of the disclosure.

### Remarks

The terms “example,” “embodiment,” and “implementation” are used interchangeably. For example, references to “one example” or “an example” in the disclosure can be, but not necessarily are, references to the same implementation; and such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described that can be exhibited by some examples and not by others. Similarly, various requirements are described that can be requirements for some examples but not for other examples.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the claims, the words “comprise,” “comprising,” and the like are to be construed in an inclusive sense, as opposed to an exclusive or exhaustive sense—that is to say, in the sense of “including, but not limited to.” As used herein, the terms “connected,” “coupled,” and any variants thereof mean any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any particular portions of this application. Where context permits, words in the above Detailed Description using the singular or plural number may also include the plural or singular number, respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes or blocks are presented in a given order, alternative implementations can perform routines having steps, or employ systems having blocks, in a different order, and some processes or blocks may be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed herein unless the above Detailed Description explicitly defines such terms. Accordingly, the actual scope of the invention encompasses not only the disclosed examples but also all equivalent ways of practicing or implementing the invention under the claims. Some alternative implementations can include additional elements to those implementations described above or include fewer elements.

Any patents and applications and other references noted above, and any that may be listed in accompanying filing papers, are incorporated herein by reference in their entireties except for any subject matter disclaimers or disavowals and except to the extent that the incorporated material is inconsistent with the express disclosure herein, in which case the language in this disclosure controls. Aspects of the invention can be modified to employ the systems, functions, and concepts of the various references described above to provide yet further implementations of the invention.

To reduce the number of claims, certain implementations are presented below in certain claim forms, but the applicant contemplates various aspects of an invention in other forms. For example, aspects of a claim can be recited in a means-plus-function form or in other forms, such as being embodied in a computer-readable medium. A claim intended to be interpreted as a means-plus-function claim will use the words “means for.” However, the use of the term “for” in any other context is not intended to invoke a similar interpretation. The applicant reserves the right to pursue such additional claim forms either in this application or in a continuing application.

1. A method for leveraging data sources into an insight generation system to generate a recommendation for a renewable energy asset, the method comprising:
combining historical operational data and real-time operational data associated with the renewable energy asset and its operational ecosystem;
incorporating historical environmental data and real-time environmental data to include multiple forecasts of weather activities, natural disasters, and atmospheric activities;
ingesting the combined and incorporated data into an insight generation engine that operates on the combined and incorporated data to produce insights; and
generating, based on an output of the insight generation engine, a particular insight that enables data-driven decisions related to operation, sustainment, and planning of a resource or resources associated with the renewable energy asset, wherein the insight is associated with optimization, execution, emplacement, or substantiality of the resource.
